(19) United States
(12) Patent Application Publication
(10) Pub. No.: US 2011/0099196 A1
(43) Pub. Date: Apr. 28, 2011

(54) Web Sites That Introduce Families To Each Other

(76) Inventor: Lewis Farsedakis, Boca Raton, FL (US)

(21) Appl. No.: 12/914,432

(22) Filed: Oct. 28, 2010

Related U.S. Application Data
(60) Provisional application No. 61/255,654, filed on Oct. 28, 2009.

(51) Int. Cl. G06F 17/30

(52) U.S. Cl. 707/769; 707/E17.014

(57) ABSTRACT

Computer-based matching of two families is provided, such as matching one family with at least two living human family members to another family with at least two living human family members.

### RELATED APPLICATION

This application claims benefit of U.S. provisional patent application Ser. No. 61/255,654 filed Oct. 28, 2009 by Lewis Farsedakis.

### FIELD OF THE INVENTION

This invention relates to the Internet, more particularly to web sites by which families are introduced to each other.

### BACKGROUND OF THE INVENTION

The Internet is a relatively recent development, with the existence of websites that bring together strangers in various ways and for various reasons being relatively recent.

### SUMMARY OF THE INVENTION

The invention in one exemplary embodiment provides a computer-based matching method of matching two families comprising: in-taking, into a computer system (with an Internet-based computer system being especially preferred), information supplied by a first family comprising at least two living human family members; in-taking, into the computer system, information supplied by a second family comprising at least two living human family members; identifying, performed by the computer system, a compatibility condition (such as, e.g., a compatibility condition in which the first family and the second family have a same configuration of adults; a compatibility condition in which the first family and the second family have a matching configuration of ages of children; a compatibility condition of eating habits; a compatibility condition of likes/dislikes; a compatibility condition as to educational level; and a combination thereof) between the information supplied by the first family and the information supplied by the second family; and introducing, performed by the computer system, the first family to the second family.

In another preferred embodiment, the invention provides a computer-based matching method of matching two families comprising: in-taking, into the computer system, information supplied by a set of families F_{1 . . . n} each family of which comprises at least two living human family members, wherein n is an integer greater than or equal to 2; offering, performed by the computer system, a search strategy screen to a searching family within the set of families, the search strategy screen configured to receive information entered by the searching family about characteristics that are wanted in another family in order for the searching family to consider being introduced thereto; identifying, performed by the computer system, a compatibility condition between the information supplied by the searching family about characteristics that are wanted in a family in order for the searching family to consider being introduced thereto and the information supplied by one or more families within the set of families; introducing, performed by the computer system, the searching family to another family within the set of families.

### DETAILED DESCRIPTION OF A PREFERRED EMBODIMENT OF THE INVENTION

In a preferred inventive embodiment, an Internet family-matching website in-takes information supplied by various respective families with each family being represented by an adult family member who enters information into the website. The website is constructed so that the entering family member is prompted to enter such information as will be useable for computer processing of that family's information against the information of other respective families who likewise enter their families' information to accomplish computer-based matching on at least one compatibility condition.

Examples of information in-taken by the computer-based system include, e.g., educational level, marital status, number of children, ages of children, family's faith, race, address or geographical information, nutrition or food preferences, health information, athletics information, likes/dislikes, etc.

The computer-based system offers for a family entering information to have a computer-based search performed on at least one compatibility condition. Examples of a compatibility condition are, e.g., similarity of children's ages between two families; sameness of a configuration of adults between two families; similarity of educational level between two families; similarity of likes/dislikes between two families; similarity of food preferences between two families; etc.

Entries for adult family members preferably are stored in a format in which examples include, e.g., an entry for family A is “adults A=mom A, dad A”; an entry for family B is “adults B=mom B, dad B”; an entry for family C is “adults C=mom C”; etc. Preferably marital status information for each adult is also in-taken by the website, for further storing whether, e.g., mom A and dad A are married to each other or not, or, in a case of a family having only one adult member whether the adult family member is divorced or widowed. Living arrangement information for each adult may be in-taken by the website, such as, e.g., whether adults entered as parents presently occupy the same household and if not, the reason such as military service, incarceration, etc. Compatibility searching in the computer-based matching step can then be performed according to the criteria of the adult family member performing the matching search. For example, a married mom and dad may define, for purposes of their matching query, other families with a married mom and dad to be compatible but families with a divorced mom only to be outside the scope of their query.

Entries for children's ages preferably are stored in a format including a total number of children and an indication of an age of each child, such as “children X=child X1 age 3, child X2 age 6” ; “children Y=child Y1 age 12, child Y2 age 18, child Y3 age 20”; etc. Compatibility searching in the computer-based matching step can then be performed according to the criteria of the adult family member performing the matching search. For example, a search for another family in which the presence of children ages 3 to 6 was input as a mandatory search criterion would return family X but would not return family Y. If the information-intake is in terms of ages rather than birth year, the computer-based system is configured to automatically update ages.

The computer-based system includes a database which is updatable both to receive new family entries into the database and to update entries for existing families represented in the database.

The database is useable, such as by one family represented in the database, to search for various other families (which are strangers to the searcher) represented in the database. One example of a search option that the website may provide to a searcher is a matching search in which a searcher is offered to search for another family in the database based on the same or similar data for the two respective families. Another example of a search option that the website may provide to a searcher is a “wanted to meet” search in which the searcher may be seeking another family that is different from his family on one or more search parameters.

A preferred example of how the website makes a search available to a family includes a step of the computer-based system providing to the searcher a list of elements for which the families have entered information for the searcher to rate or rank for importance. For example, if the families have entered information about race, gender, health/nutrition, athletics, children's ages and socioeconomic position into the website, then a searcher from among the families entering such information may be presented with a screen listing those elements and asking the searcher to answer, from 1 to 5 with 5 being mandatory need for a match or a mismatch, how important it is to the searcher for that element to be matched or different.

In some embodiments, the computer-based system also intakes information regarding pets that are part of the family, such as a computer-based system that intakes information for a category of adults in the family, a category of children in the family, and a category of pets in the family, and respectively stores such information for use in subsequent steps such as searching, identifying, matching and introducing steps.

It will be appreciated that variations and modifications from the embodiments set forth above may be made without departing from the spirit of the invention, and that such modifications are to be considered within the present invention.

What I claim as my invention is:

1. A computer-based matching method of matching two families comprising:
in-taking, into a computer system, information supplied by a first family comprising at least two living human family members;
in-taking, into the computer system, information supplied by a second family comprising at least two living human family members;
identifying, performed by the computer system, a compatibility condition between the information supplied by the first family and the information supplied by the second family;
introducing, performed by the computer system, the first family to the second family.

2. The method of claim 1, including the computer system's identifying a compatibility condition in which the first family and the second family have a same configuration of adults and/or a compatibility condition in which the first family and the second family have a matching configuration of ages of children.

3. A computer-based matching method of matching two families comprising:
in-taking, into the computer system, information supplied by a set of families F_{1 . . . n} each family of which comprises at least two living human family members, wherein n is an integer greater than or equal to 2;
offering, performed by the computer system, a search strategy screen to a searching family within the set of families, the search strategy screen configured to receive information entered by the searching family about characteristics that are wanted in another family in order for the searching family to consider being introduced thereto;
identifying, performed by the computer system, a compatibility condition between the information supplied by the searching family about characteristics that are wanted in a family in order for the searching family to consider being introduced thereto and the information supplied by one or more families within the set of families;
introducing, performed by the computer system, the searching family to another family within the set of families.
